(19) United States
(12) Patent Application Publication
(10) Pub. No.: US 2015/0186586 A1
(43) Pub. Date: Jul. 2, 2015

(54) INTEGRATED CIRCUIT LAYOUTS AND METHODS TO IMPROVE PERFORMANCE

(71) Applicant: Samsung Electronics Co., Ltd., Suwon-si (KR)

(72) Inventors: Santhosh PILLAI, San Jose, CA (US); Harpreet GILL, San Jose, CA (US)

(73) Assignee: Samsung Electronics Co., Ltd., Suwon-si (KR)

(21) Appl. No.: 14/286,968

(22) Filed: May 23, 2014

Related U.S. Application Data
(60) Provisional application No. 61/922,089, filed on Dec. 30, 2013.

(51) Int. Cl. G06F 17/50

(52) U.S. Cl. CPC G06F 17/5072; G06F 17/5009

(57) ABSTRACT

An embodiment includes a method, comprising: receiving a netlist associated with an integrated circuit; identifying a parameter of a cell in the netlist; associating the cell with a reserved area in response to the parameter; and placing the cell in a layout for the integrated circuit with the reserved area.

### BACKGROUND

This disclosure relates to integrated circuit layouts and methods, and, in particular, integrated circuit layouts and methods to improve performance.

Different techniques may be used to place decoupling capacitors in layouts of integrated circuits. A first technique includes placing decoupling capacitors after performing place and route for the layout. However, a space for a decoupling capacitor may not be available where desired. A second technique includes pre-placing decoupling capacitors in a regular fashion. This technique allows for some availability of decoupling capacitors in a given region; however, the decoupling capacitors may still not end up where desired. Further, this method comes at the price of increased area requirements. Combining these methods still may not provide desired decoupling capacitor placement.

### SUMMARY

An embodiment includes a method, comprising: receiving a netlist associated with an integrated circuit; identifying a parameter of a cell in the netlist; associating the cell with a reserved area in response to the parameter; and placing the cell in a layout for the integrated circuit with the reserved area.

Another embodiment includes a system, comprising: a memory configured to store a netlist associated with an integrated circuit; a processor coupled to the memory and configured to: identifying a parameter of a cell in the netlist; associating the cell with a reserved area in response to the parameter; and placing the cell in a layout for the integrated circuit with the reserved area.

Another embodiment includes a computer readable medium storing instructions, comprising: instructions for receiving a netlist associated with an integrated circuit; instructions for identifying a parameter of a cell in the netlist; instructions for associating the cell with a reserved area in response to the parameter; and instructions for placing the cell in a layout for the integrated circuit with the reserved area.

### BRIEF DESCRIPTION OF SEVERAL VIEWS OF THE DRAWINGS

FIG. 1 is a block diagram illustrating creating a layout according to an embodiment.

FIG. 2 is a schematic view of multiple cells with reserved areas according to various embodiments.

FIG. 3 is a schematic view of multiple cells with decoupling capacitors according to an embodiment.

FIG. 4 is a block diagram illustrating creating a layout according to an embodiment.

FIG. 5 is a block diagram illustrating modifying a layout according to an embodiment.

FIG. 6 is a schematic view of a cell and decoupling capacitor before and after modification according to an embodiment.

FIG. 7 is a schematic view of multiple cells and reserved areas before and after a cell is moved according to an embodiment.

FIG. 8 is a schematic view of multiple cells placed relative to a power rail according to an embodiment.

FIG. 9 is a schematic view of cells having the same type with different reserved areas according to an embodiment.

FIG. 10 is a schematic view of an electronic system according to an embodiment.

### DETAILED DESCRIPTION

Embodiments relate to integrated circuits with improved performance. The following description is presented to enable one of ordinary skill in the art to make and use the embodiments and is provided in the context of a patent application and its requirements. Various modifications to the exemplary embodiments and the generic principles and features described herein will be readily apparent. The exemplary embodiments are mainly described in terms of particular methods and systems provided in particular implementations.

However, the methods and systems will operate effectively in other implementations. Phrases such as “exemplary embodiment”, “one embodiment” and “another embodiment” may refer to the same or different embodiments as well as to multiple embodiments. The embodiments will be described with respect to systems and/or devices having certain components. However, the systems and/or devices may include more or less components than those shown, and variations in the arrangement and type of the components may be made without departing from the scope of this disclosure. The exemplary embodiments will also be described in the context of particular methods having certain steps. However, the method and system operate effectively for other methods having different and/or additional steps and steps in different orders that are not inconsistent with the exemplary embodiments. Thus, embodiments are not intended to be limited to the particular embodiments shown, but are to be accorded the widest scope consistent with the principles and features described herein.

The exemplary embodiments are described in the context of particular systems having certain components. One of ordinary skill in the art will readily recognize that embodiments are consistent with the use of systems having other and/or additional components and/or other features. The methods and systems are also described in the context of single elements. However, one of ordinary skill in the art will readily recognize that the method and system are consistent with the use of systems having multiple elements.

It will be understood by those skilled in the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to examples containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. Furthermore, in those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

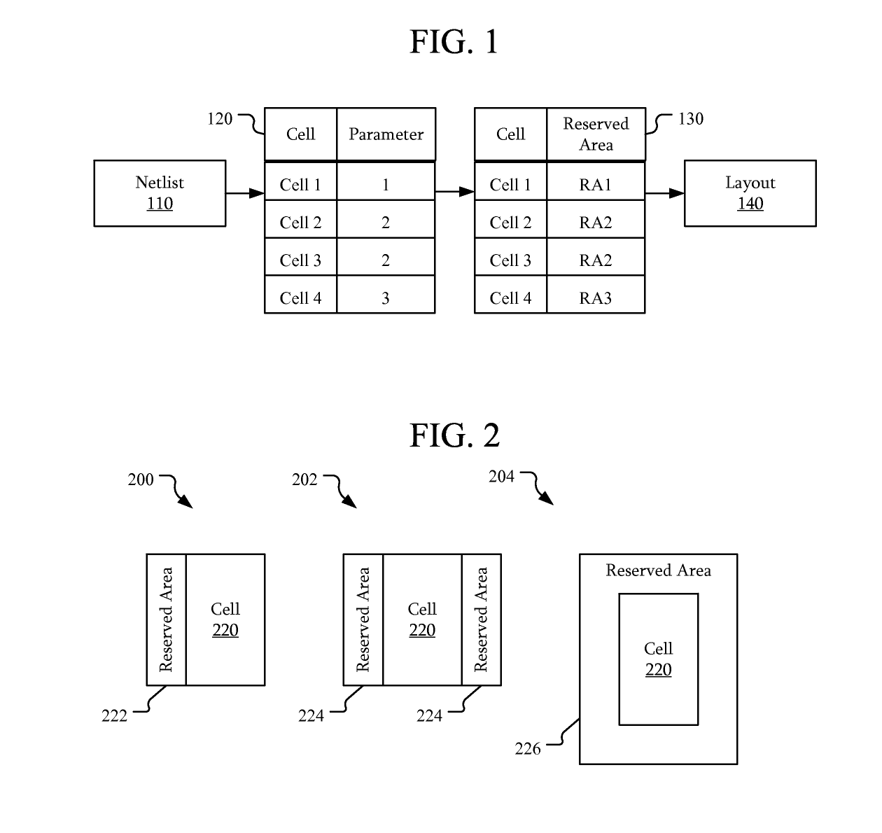

FIG. 1 is a block diagram illustrating creating a layout according to an embodiment. In this embodiment, a netlist 110 is received. The netlist 110 is associated with an integrated circuit. The netlist 110 includes information representing a plurality of cells.

A parameter for the cells of the netlist 110 may be identified. Table 120 represents an association of cells and parameters. Here, cells Cell 1, Cell 2, Cell 3, and Cell 4 represent different instances of cells. However, in other embodiments, cells Cell 1, Cell 2, Cell 3, and Cell 4 may represent master cells that are used to create particular instances. A cell may be a combination of circuits, gates, single instances of such elements, or the like. Regardless, the parameter for each cell may be identified. Here, arbitrary values of 1, 2, and 3 are used as examples. The parameter may be any variety of parameters related the cell.

In an embodiment, the parameter may be correlated with a contribution to an instantaneous voltage drop (IVD) attributable to the cell. For example, the parameter may include simulation results for the cell from a simulation of the netlist 110 using a functional and/or test-mode vector. In a particular example, with functional and/or test-mode vectors, the higher-switching cells may be identified. That is, the parameter may be a relative indication of an amount of switching that a given cell may perform during operation.

Although the parameter may be determined in response to a single vector, in other embodiments, multiple vectors and the associated results may be used to determine the parameter. For example, in response to a first mission-mode vector, an amount of switching may have a first value, while in response to a second test-mode vector, the amount of switching may have a second value. The parameter may be determined in response to the first value, the second value, a combination of the values, a maximum or minimum of the values, or the like.

In another example, the parameter may be determined in response to a clock frequency of the cell. In yet another example, the parameter may be determined in response to a power consumption of the cell. Moreover, in the absence of a vector, power analysis may be performed in a vectorless mode. In response to the power analysis, a power consumption of cells can be identified and used to determine the parameter of the cell. In other examples, the parameter may be a combination of such parameters, such as a combination of a clock frequency and a power consumption.

Although particular examples of parameters have been given, the parameter associated with the cell may, but need not be the exact value determined from the analysis. For example, in one embodiment, the parameter may be the number of times a cell switches in a particular simulation. However, in another embodiment, the parameter may be an enumerated value indicating whether the cell has a lower, middle, or higher level of switching.

Although the parameter has been described in the context of a value correlated with a contribution to an instantaneous voltage drop attributable to the cell, the parameters may be related to other attributes of a cell. For example, the parameter may be related to a susceptibility of an operation of the cell to noise, a probability that the cell could affect other adjacent cells, an amount of routing for the cell, or the like.

In response to the parameter, the cell may be associated with a reserved area. The reserved area is an area to be placed around or substantially adjacent to the associated cell in the layout 140. Here, table 130 represents an association of cells to reserved areas.

In an embodiment, the reserved area may be described in a variety of ways. For example, the reserved area may be described as a side or sides of the cell on which the reserved area is located. The reserved area may also include one or more dimensions, such as a distance from an edge of the cell over which the reserved area extends. In yet another example, as will be described in further detail below, a decoupling capacitor may be placed in the reserved area. Accordingly, the reserved area may include a value of capacitance, an indication of a particular decoupling capacitor, or the like.

Once the reserved area is determined, the cell may be placed in the layout 140 with the reserved area. Although a reserved area has been described as being placed in the layout 140, the reserved area may be implemented differently. For example, the reserved area may be implemented as meta-data associated with the cell to be used during placing and routing the layout 140.

FIG. 2 is a schematic view of multiple cells with reserved areas according to various embodiments. In an embodiment, an association 200 may include a reserved area 222 disposed on a side of a cell 220. In another embodiment, an association 202 may include reserved areas 224 on two side of a cell 220. In yet another example, a reserved area 226 may extend around the cell 220.

The associations 200, 202, and 204 represent the relationship between the reserved area and the cell in the layout. However, once a reserved area is determined for a cell, the reserved area may, but need not be immediately placed with the cell. For example, the cell 220 and reserved area 222 may not be adjacent until placed in the layout.

As described above, a reserved area may be determined for a cell 220. For example, referring to the table 130 of FIG. 1, a reserved area RA1 may correspond to the association 200. Accordingly, when cell Cell 1 is placed in the layout 140, a reserved area 222 is placed adjacent to cell Cell 1. Similarly, reserved area RA2 and RA3 may correspond to associations 202 and 204, respectively. When cells Cell 2 and Cell 3 are placed, reserved areas 224 and 226, respectively, may be placed as well.

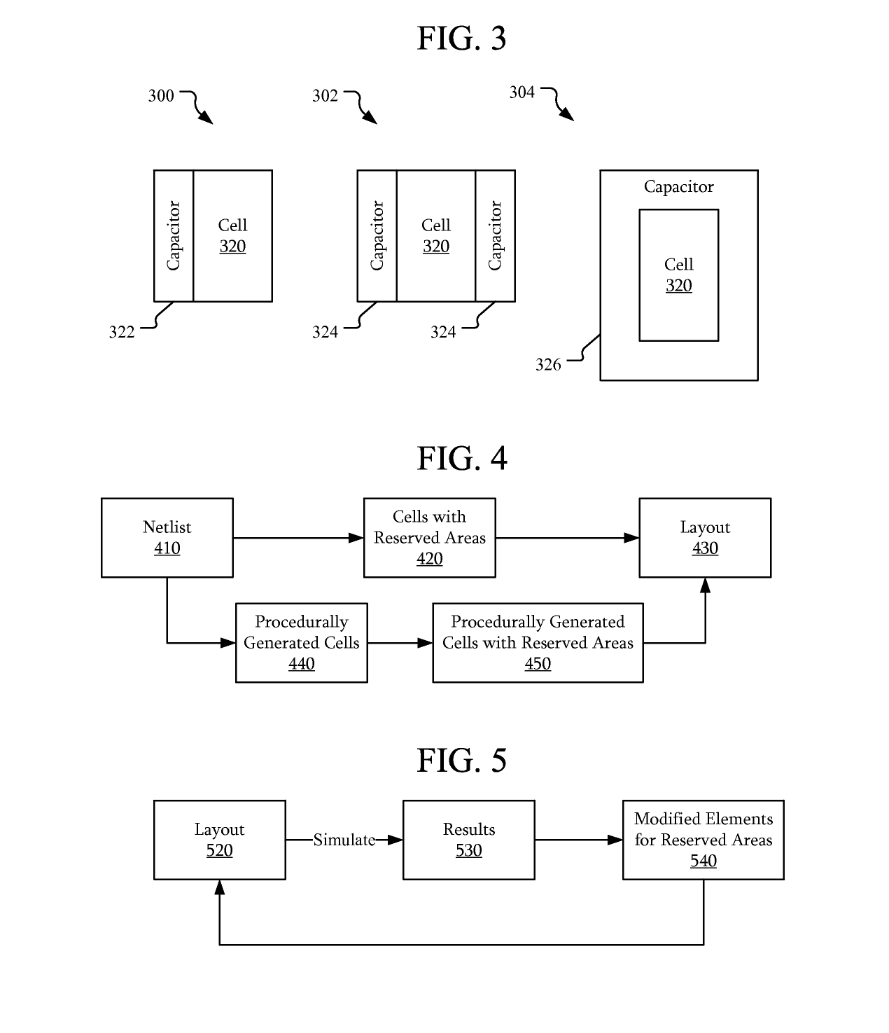

FIG. 3 is a schematic view of multiple cells with decoupling capacitors according to an embodiment. In an embodiment, a decoupling capacitor may be placed in the layout in the reserved area. Layout portions 300, 302, and 304 correspond to portions of the layout where a reserved area was determined similar to associations 200, 202, and 204 of FIG. 2; however, decoupling capacitors 322, 324, and 326 have been placed in the reserved areas 222, 224, and 226, respectively.

In an embodiment, for higher speed, more complex designs, designs with advanced process nodes, or the like, transistor density may increase due to the shrinking of process nodes. As a result, power density may increase. Accordingly, average, dynamic, and peak power may increase. In addition, IVD may increase, which may affect timing and functionality. Decoupling capacitors may be placed substantially adjacent to switching cells, such as cells 320 to reduce IVD.

In an embodiment, the parameter may be a switching current. Before placement, an amount of switching current for the cells may be determined before the cells are placed. From the switching current of the cells, a table with cell vs decoupling capacitor may be generated. The decoupling capacitor may be selected in response to a maximum switching current for all buffers, combinational and sequential cells, or the like. In particular, the table may be created with an entry for each instance of the cells.

The amount of switching may be used to select a decoupling capacitor for the cell. For the instances that have a higher switching current, the reserved area, and hence the subsequently placed decoupling capacitor area may be larger. For example, a cell 320 with a higher switching current may be placed with capacitor 326, i.e., a larger decoupling capacitor.

Once the capacitor is placed, as will be described in further detail below, the capacitor may move with the cell 320. However, in other embodiments, the reserved area need not be filled with a capacitor until after initial placement, after routing, or the like. Since the reserved area is placed, the capacitor may be placed at a later time regardless of how the cell has moved. As a result, a lack of space at a later stage in the design will have a reduced, if not eliminated effect as the decoupling capacitors have already been placed or space has been reserved for the decoupling capacitors that moves with the cell 320.

FIG. 4 is a block diagram illustrating creating a layout according to an embodiment. In an embodiment, the netlist 410 may be used to generate cells with reserved areas 420 as described above. These cells and reserved areas 420 may be placed in the layout 430.

In addition to the cells defined in the netlist 410, procedurally generated cells 440 may be generated in response to the netlist 410. For example, the procedurally generated cells 440 may be clock tree buffers. Clock tree buffers that are not originally in the netlist 410 may be procedurally generated by a clock tree synthesis algorithm.

As described above, each instance of a cell may be associated with a reserved area specific to that cell. In an embodiment, for procedurally generated cells 440, a master cell with a predefined reserved area may be used to generate procedurally generated cells with reserved areas 450 for placement in the layout 430. For example, a clock tree synthesis may result in a variety of different buffers being specified for the clock tree, such as buffers with a 16×, 12×, 10×, or the like drive capability. However, as the clock tree buffers were not present in the netlist 410, simulation results, power analysis, or the like as described above may not be available to generate parameters for cells of the clock tree buffers. Accordingly, for each different type of buffer, a reserved area may be selected. The reserved areas may be the same or different for each type of buffer. For example, a 16× buffer may have a first reserved area while 12× and 10× buffers may have a different second reserved area. That is, a particular cell type used in the procedurally generated cells 440 may be paired with a single reserved area type. In a particular embodiment, the pair of a master cell and a reserved area may be predefined; however, in other embodiments, the pairing may be based on other factors, such as results of a clock tree synthesis algorithm.

In an embodiment, a clock tree synthesis algorithm may generate a master buffer list and a current profile table. The current profile table may be used similar to the parameters described above to select a reserved area. However, as the association between the current profile and a buffer is at a master cell level rather than an instance level, each procedurally generated cell type may be associated with one reserved area rather than each cell instance.

In an embodiment, cells that are procedurally generated may be the same as other cells in the netlist 410. However, a relationship of procedurally generated cells 440 to reserved areas need not be maintained for other instances of cells. For example, although a master cell for procedurally generated cells 440 may be associated with only one reserved area, other instances of the master cell outside of procedurally generated portions may have individually different reserved areas based on the particular instance as described above.

FIG. 5 is a block diagram illustrating modifying a layout according to an embodiment. In this embodiment, a layout 520 may be created as described above. A simulation of the layout 520 representing a performance of an integrated circuit may be performed. For example, the layout 520 may be analyzed after routing to determine parasitic effects. The parasitic effects may be used to simulate the operation of the integrated circuit, perform a power analysis, perform an instantaneous voltage analysis, or the like.

In particular, the parameters described above may have been generated using worst-case considerations, such as a maximum switching current. After routing, cells may be configured to drive shorter wires, less fanouts, or the like and may accordingly have less than the maximum switching currents. The results 530 may be used to create modified elements for the reserved areas 540. These modified elements 540 may be used to update the layout 520. Although in some embodiments, this technique may be performed once, in other embodiments, the technique may be performed multiple times.

In an embodiment, the decoupling capacitors of a cell may be changed in response to the performance without moving the cell or any adjacent cells. In particular, adjacent cells that are not switching during operation may have a decoupling effect similar to a decoupling capacitor. As a result, a smaller capacitance may be used. If an amount of placed capacitance is more than is needed, a capacitor with less capacitance may be selected. Although a smaller capacitor may be used in the same area, in other embodiments, a different type of capacitor may be used. For example, a capacitor that is substantially the same size but a different type may be used in place of the original capacitor. Such a capacitor may have a smaller capacitance, but also a smaller leakage, higher reliability, or the like. Accordingly, a design may be optimized to reduce leakage by reducing capacitance, changing a capacitor type, or the like. Moreover, because the replacement decoupling capacitor is placed in the same area, no movement of cells, rerouting, or the like needs to be performed.

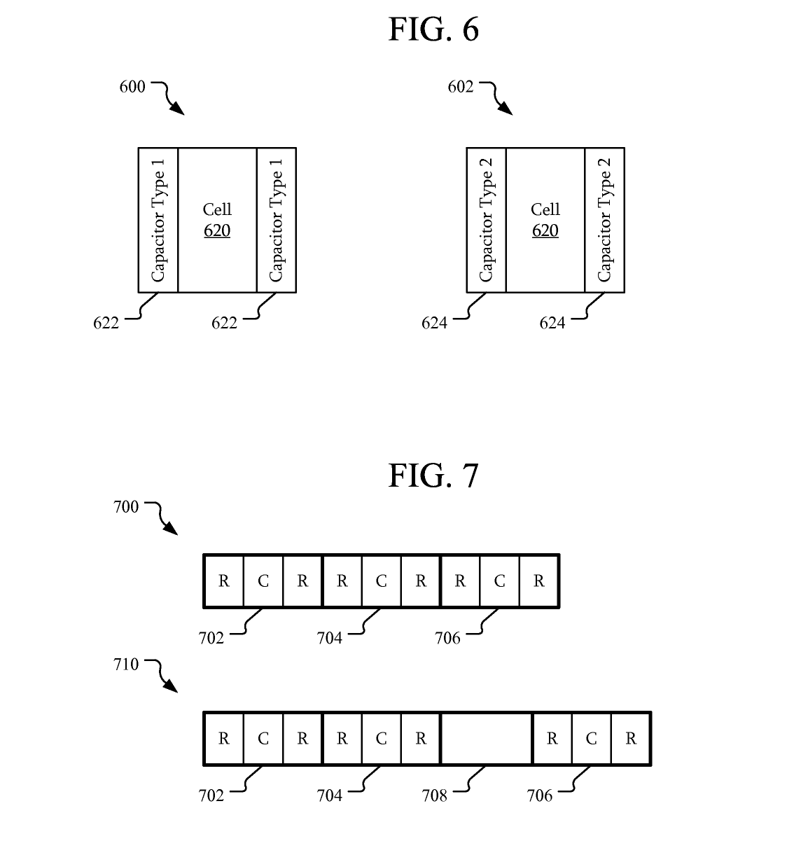

FIG. 6 is a schematic view of a cell and decoupling capacitor before and after modification according to an embodiment. Referring to FIGS. 5 and 6, in this embodiment, layout portion 600 was placed in layout 520 with cell 620 and capacitors 622 of a first type. However, after the simulation, the types of the capacitors 622 are changed to a second type. Layout portion 602 represents the same cell 620 with different capacitors 624. Although the layout portion 602 is illustrated as separate, the cell 620 is the same cell in the layout 520; however, the capacitors 622 were replaced in the same position with the capacitors 624. Although the same position has been used to described the location of the capacitors 622 and 624, depending on the type, size, terminals, or the like of the capacitor 624, the capacitor 624 may be in a different position, orientation, or the like but still be within the bounds of the reserved area within which the original capacitor 622 was placed. As a result, no change in the position of the cell 620 or adjacent cells is required.

FIG. 7 is a schematic view of multiple cells and reserved areas before and after a cell is moved according to an embodiment. In this embodiment, layout portion 700 is a portion of the layout where multiple cells C and reserved areas R have been placed. Here, associations 702, 704, and 706 are illustrated, each with a cell C and reserved areas R; however, the particular reserved area R is merely used as an example and may be a different reserved area, different reserved area for different cells C, or the like.

Layout portion 710 represents substantially the same portion of the layout as layout portion 700; however, association 706 has moved. For example, during placing, routing, or other manipulations of the layout, the cell C of association 706 may be moved. In a particular example, an area 708 may be needed for another cell or other structure. Regardless, when the cell C is moved, the reserved areas R of the association 706 are also moved with the cell C. As a result, in an embodiment, the decoupling capacitor or a reserved area for the decoupling capacitor that was determined for the cell C of association 706 remains with the cell C. In a particular embodiment, the reserved areas R may be passed to a placer tool so that legal placement for those cells C may keep the reserved space R substantially adjacent. In addition, the reserved area may act like a moving bound, such that any further movement of placed cells in subsequent place and route steps will still keep this space available.

Although movement of the cell C of association 706 is used as an example, the reason that the cell C was moved may, but need not be the impetus to open the area 708. For example, a reserved area R may have been in a location that is needed for another purpose. Because the reserved area R is associated with the cell C in the association 706, the cell C and all of the reserved areas R of the association 706 are moved.

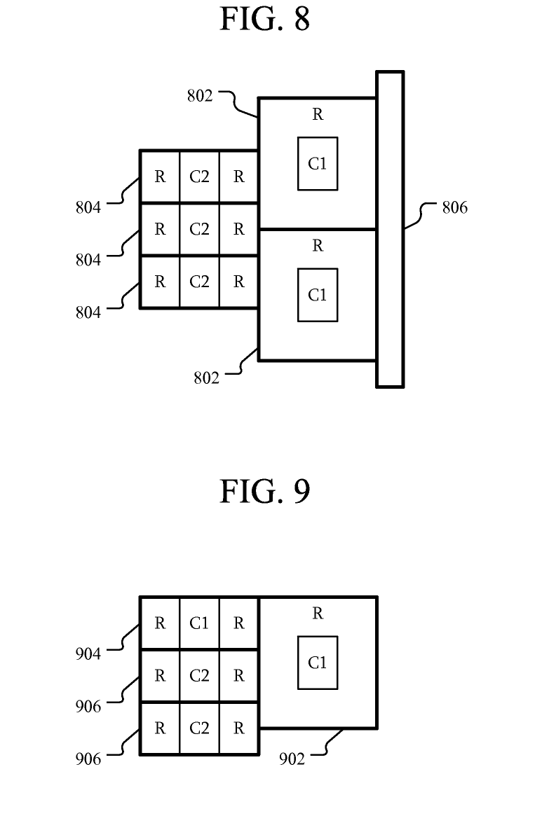

FIG. 8 is a schematic view of multiple cells placed relative to a power rail according to an embodiment. In this embodiment, multiple cells C and associated reserved areas R are placed near switch cells 806. However, some associations 802 of cell C1 and reserved area R are placed closer to the switch cells 806 than other associations 804 of cell C2 and reserved area R.

In an embodiment, the parameters described above used to determine a reserved area may be further used to determine a relative location of the association. For example, the parameter may be compared with a threshold. If the parameter is greater than the threshold, i.e., the parameter indicates that the cell of the association needs a greater reserved area for a larger capacitance than cells with parameters below the threshold, the association including the cell 802 may be placed substantially adjacent to the switch cells 806. Other associations, such as association 804, may be placed further from the switch cells 806 if the corresponding parameter is lower than the threshold.

In a particular example, about 2-5% of the cells may be selected to be placed closer, if not adjacent to the switch cells 806. The threshold may be determined to establish such a proportion of cells to be closer to the switch cells 806.

FIG. 9 is a schematic view of cells having the same type with different reserved areas according to an embodiment. As illustrated in this embodiment, an association of cells to reserved areas need not be the same for each type of cell. For example, in association 902, cell C1 is associated with a reserved area R that substantially surrounds the cell C1. However, in association 904, the same type of cell, cell C1, has a different reserved area R disposed on two sides of the cell C1. This may, but need not mean that the same cells must have different reserved areas R. For example, associations 906 have the same cell C2 and the same reserved area R disposed on two sides of the cell C2.

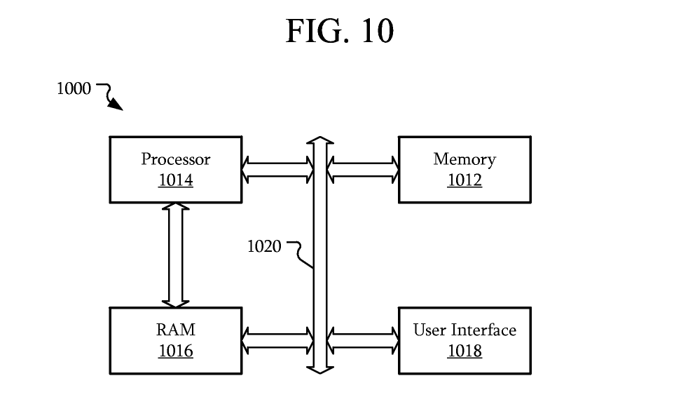

FIG. 10 is a schematic view of an electronic system according to an embodiment. The electronic system 1000 may be part of a wide variety of electronic devices including, but not limited to, servers, workstations, portable notebook computers, Ultra-Mobile PCs (UMPC), Tablet PCs, mobile telecommunication devices, and so on. Any system that may process, simulate, or otherwise manipulate a layout of an integrated circuit may include the electronic system 1000. For example, the electronic system 1000 may include a memory system 1012, a processor 1014, RAM 1016, and a user interface 1018, which may execute data communication using a bus 1020.

The processor 1014 may be a microprocessor or a mobile processor (AP). The processor 1014 may have a processor core (not illustrated) that can include a floating point unit (FPU), an arithmetic logic unit (ALU), a graphics processing unit (GPU), and a digital signal processing core (DSP Core), or any combinations thereof. The processor 1014 may execute the program and control the electronic system 1000. The processor 1014 may be configured to perform some or all of the operations described above. In a particular embodiment, the processor 1014 may be configured to execute an electronic design automation (EDA) tool configured to perform some or all of the operations described above.

The RAM 1016 may be used as an operation memory of the processor 1014. Alternatively, the processor 1014 and the RAM 1016 may be packaged in a single package body. The RAM 1016 may be configured to store a layout, simulation results, netlist, or the like described above during processing as described above.

The user interface 1018 may be used in inputting/outputting data to/from the electronic system 1000. For example, the user interface 1018 may include a display configured to present a layout, simulation results, netlist, or the like to a user. The user interface 1018 may also include a pointing device, a keyboard, or other input devices configured to allow a user to interact with such information. Moreover, the user interface 1018 may include a network interface configured to receive a netlist, simulation results, communicate with another electronic system for such information, or the like.

The memory system 1012 may store codes for operating the processor 1014, data processed by the processor 1014, or externally input data. The memory system 1012 may include a controller and a memory. The memory system 1012 may include an interface to computer readable media. Such computer readable media may store instructions to perform the variety of operations describe above. In addition, the memory system 1012 may be configured to store a layout, simulation results, netlist, or the like.

Using the techniques described above a layout for an integrated circuit may be created with reserved areas that may improve performance of an integrated circuit. Accordingly, integrated circuits may be fabricated using a layout described above.

Although the structures, methods, and systems have been described in accordance with exemplary embodiments, one of ordinary skill in the art will readily recognize that many variations to the disclosed embodiments are possible, and any variations should therefore be considered to be within the spirit and scope of the apparatus, method, and system disclosed herein. Accordingly, many modifications may be made by one of ordinary skill in the art without departing from the spirit and scope of the appended claims.

1. A method, comprising:
receiving a netlist associated with an integrated circuit;
identifying a parameter of a cell in the netlist;
associating the cell with a reserved area in response to the parameter; and
placing the cell in a layout for the integrated circuit with the reserved area.

2. The method of claim 1, further comprising placing a decoupling capacitor in the layout for the cell in the reserved area.

3. The method of claim 2, further comprising:
simulating a performance of the integrated circuit using the layout; and
changing the decoupling capacitor of the cell in response to the performance without moving the cell or any adjacent cells.

4. The method of claim 1, wherein the parameter includes an indication of an amount of switching the cell will perform when operating.

5. The method of claim 1, wherein identifying the parameter of the cell comprises:
simulating the netlist using a functional test vector to generate simulation results; and
determining the parameter of the cell in response to the simulation results.

6. The method of claim 1, wherein identifying the parameter of the cell comprises:
determining a clock frequency associated with the cell; and
determining the parameter of the cell in response to the clock frequency.

7. The method of claim 1, wherein identifying the parameter of the cell comprises:
performing a power analysis of the netlist; and
determining the parameter of the cell in response to the power analysis.

8. The method of claim 1, wherein placing the cell in the layout comprises placing the reserved area on at least two sides of the cell.

9. The method of claim 1, wherein placing the cell in the layout comprises placing the reserved area substantially surrounding the cell.

10. The method of claim 1, further comprising:
moving the cell in the layout; and
moving the reserved area with the cell when moving the cell.

11. The method of claim 1, further comprising:
determining if the parameter is greater than a threshold; and
placing the cell in the layout substantially adjacent to a switch cell if the parameter is greater than the threshold.

12. The method of claim 1, further comprising procedurally generating a portion of the layout including selecting a predefined cell and decoupling structure pair for the portion.

13. The method of claim 1, wherein:
the cell is a same type of cell as another cell in the netlist; and
further comprising:
identifying a parameter of the other cell; and
if the parameter of the other cell is different from the parameter of the cell:
associating the other cell with a different reserved area in response to the parameter of the other cell; and
placing the other cell in the layout for the integrated circuit with the different reserved area.

14. A system, comprising:
a memory configured to store a netlist associated with an integrated circuit;
a processor coupled to the memory and configured to:
identifying a parameter of a cell in the netlist;
associating the cell with a reserved area in response to the parameter; and
placing the cell in a layout for the integrated circuit with the reserved area.

15. The system of claim 14, wherein the processor is further configured to place a decoupling capacitor in the layout for the cell in the reserved area.

16. The system of claim 15, wherein the processor is further configured to:
simulate a performance of the integrated circuit using the layout; and
change the decoupling capacitor of the cell in response to the performance without moving the cell or any adjacent cells.

17. The system of claim 14, wherein the processor is further configured to:
move the cell in the layout; and
move the reserved area with the cell when moving the cell.

18. The system of claim 14, wherein the processor is further configured to procedurally generate a portion of the layout including selecting a predefined cell and decoupling structure pair for the portion.

19. The system of claim 14, wherein:
the cell is a same type of cell as another cell in the netlist; and
the processor is further configured to:
identify a parameter of the other cell; and
if the parameter of the other cell is different from the parameter of the cell:
associate the other cell with a different reserved area in response to the parameter of the other cell; and
place the other cell in the layout for the integrated circuit with the different reserved area.

20. A computer readable medium storing instructions, comprising:
instructions for receiving a netlist associated with an integrated circuit;
instructions for identifying a parameter of a cell in the netlist;
instructions for associating the cell with a reserved area in response to the parameter; and
instructions for placing the cell in a layout for the integrated circuit with the reserved area.
